(19) United States
(12) Patent Application Publication
(10) Pub. No.: US 2003/0130836 A1
(43) Pub. Date: Jul. 10, 2003

(54) Evaluation system of vocabulary knowledge level and the method thereof

(75) Inventors: Jackson Chang, Taipei (TW); Yu-Ying Anita Liang, Taipei (TW)

Correspondence Address: SUGHRUE MION, PLLC, 2100 PENNSYLVANIA AVENUE, N.W., WASHINGTON, DC, 20037, US

(73) Assignee: INVENTEC CORPORATION

(21) Appl. No.: 10/036,530

(22) Filed: Jan. 7, 2002

(51) Int. Cl. G06F 17/28

(52) U.S. Cl. 704/8

(57) ABSTRACT

An evaluation system of vocabulary knowledge level and the method thereof are disclosed. More particularly, the present invention relates to a system that evaluates the user's vocabulary knowledge level and provides a plurality of words and phrases that are suitable for an user automatically according to the words or vocabularies entered by the user in a bilingual operating system, such as an English-Chinese/Chinese-English, a Japanese-Chinese/Chinese-Japanese, a Japanese-English/English-Japanese, and an English-Korean/Korean-English bilingual dictionary inquiry system, etc. Therefore, by utilizing the present invention, the user does not need to go through trivial tests before using an inquiry system, and the evaluation system can process a lot of words and phrases simultaneously and automatically detect the user's vocabulary knowledge level.

### FIELD OF THE INVENTION

The present invention relates to an evaluation system of vocabulary knowledge level and the method thereof. More particularly, the present invention relates to a system that evaluates an user's vocabulary knowledge level and provides a plurality of words and phrases that matches user's level automatically according to the words or vocabularies entered by the user in a bilingual operating system. Therefore, before searching for a vocabulary, the user does not need to take numerous complicated tests for evaluating his vocabulary knowledge level.

### BACKGROUND OF THE INVENTION

Due to knowledge explosion and the progress of information technologies, people have more opportunities to be exposed to the rest of the world, and can readily obtain books or journals published in different languages. No matter how well people are good at foreign languages, they still more or less need the assistance of dictionaries while reading foreign-language publications. Except conventional dictionaries, bilingual vocabulary inquiry systems, such as English-Chinese/Chinese-English, Japanese-Chinese/Chinese-Japanese, Japanese-English/English-Japanese and English-Korean/Korean-English systems, etc., can also be utilized to obtain desired language information with more convenience and quickness.

However, with the conventional bilingual vocabulary inquiry systems, an user is only allowed to enter one word at each time of inquiry. For example, with a Far East English-Chinese Encyclopedia published by Far East Book Company of Taiwan, only one word is allowed to be entered at each time of inquiry. The inquiry method not only is inefficient, but also provides less information to the user. Moreover, when the user needs to look up a lot of words, the user has to spend a lot of time in entering those words one by one. Hence, the conventional bilingual vocabulary inquiry systems are very inconvenient for use.

Another conventional bilingual vocabulary inquiry system requires the user to take a plurality of tests provided by the conventional bilingual vocabulary inquiry system for determining the user's vocabulary knowledge level before the user can make an inquiry. Then, based on the user's vocabulary knowledge level graded from the tests, the conventional bilingual vocabulary inquiry system will first finds the words that are unfamiliar to the user and related to the word source, such as words, texts and documents, etc., entered by the user, and then displays the meanings of those words found.

However, since the user has to take tests every time before using the conventional bilingual vocabulary inquiry system, not only a lot of time is wasted, but also the user would be familiar with the correct answers of the tests after practicing the tests a couple of times, so that the user's vocabulary knowledge level used as a reference in the conventional bilingual vocabulary inquiry system cannot be obtained correctly from the tests. Thus, for providing a proper and convenient inquiry method to the user, an evaluation system is needed to be developing.

### SUMMARY OF THE INVENTION

In view of the background of the invention described above, the conventional bilingual vocabulary inquiry system utilizes some fixed tests to determine the user's vocabulary knowledge level before each time of inquiry. Not only a lot of time is wasted, but also the user would know the answers of the tests well after practicing a couple of times. Therefore, the vocabulary knowledge level obtained by utilizing the tests is inappropriate, so that the conventional bilingual vocabulary inquiry system cannot provide a plurality of proper vocabularies to the user.

It is the principal object of the present invention to provide an evaluation system of vocabulary knowledge level and the method thereof. By utilizing the present invention, an user does not need to go through the trivial tests before searching for vocabulary, and the user's vocabulary knowledge level can be detected and obtained automatically by evaluating the text entered by the user, so that the problem of evaluating the user's vocabulary knowledge level by an inconvenient method in the traditional inquiry system is resolved.

In accordance with the aforementioned objects of the present invention, the present invention provides an evaluation system of vocabulary knowledge level and the method thereof. In the present invention, based on a classification of vocabulary levels, the text entered by the user is first evaluated for obtaining the vocabulary levels of the text. Then, according to the vocabulary levels of the text, the text is divided into a plurality of word groups, and then the evaluations procedure is performed for obtaining the user's vocabulary knowledge level. Therefore, without going through the trivial tests before searching for vocabulary, the user is able to correctly get the proper vocabularies and phrases that are unfamiliar to the user.

### BRIEF DESCRIPTION OF THE DRAWINGS

The foregoing aspects and many of the attendant advantages of the present invention will become more readily appreciated as the same becomes better understood by reference to the following detailed description, when taken in conjunction with the accompanying drawings, wherein:

FIG. 1 shows a hardware structure diagram of a preferred embodiment of the present invention.

FIG. 2 is a flow chart showing the operational procedure for searching for vocabulary according to a preferred embodiment of the present invention.

FIG. 3 is a flow chart showing the operational procedure of the evaluation procedure step 207 shown in FIG. 2.

FIG. 4 is a table showing the classification of vocabulary levels in a preferred embodiment of the present invention.

FIG. 5 is a diagram showing several methods for evaluating user's knowledge level of a preferred embodiment of the present invention.

FIG. 6 is a first article in the preferred embodiment of the present invention.

FIG. 7 is a second article in the preferred embodiment of the present invention.

FIG. 8 is a third article in the preferred embodiment of the present invention.

FIG. 9 is a table showing the vocabulary levels and the word group levels by applying Method 1 on a combination of the first article, the second article and the third article simultaneously, according to the preferred embodiment of the present invention.

FIG. 10 is a diagram showing the total evaluation result according to FIG. 9.

FIG. 11 is a table showing the vocabulary levels and the word group levels by applying Method 2 on a combination of the first article, the second article and the third article simultaneously, according to the preferred embodiment of the present invention.

FIG. 12 is a diagram showing the total evaluation result according to FIG. 11.

### DETAILED DESCRIPTION OF THE PREFERRED EMBODIMENT

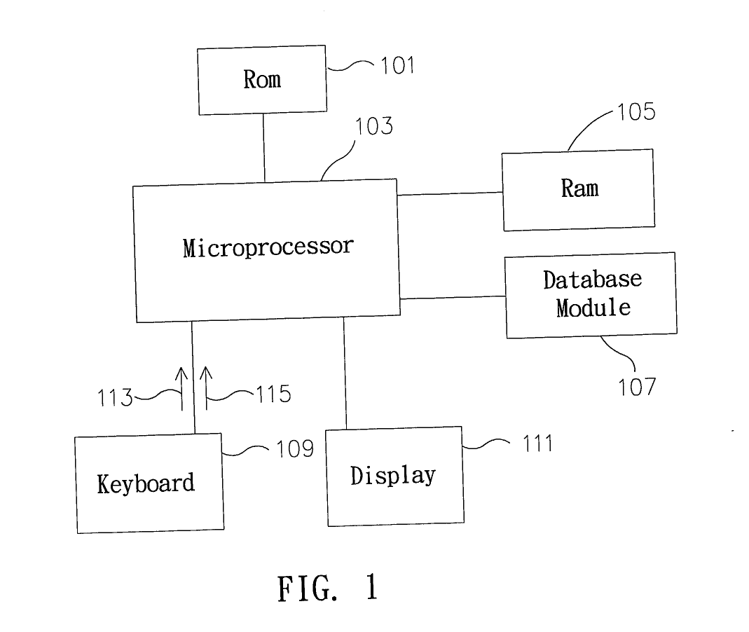

Referring to FIG. 1, FIG. 1 shows a hardware structure diagram of a preferred embodiment of the present invention. In FIG. 1, the hardware structure of the present invention comprises a read only memory (ROM) 101, a microprocessor 103, a random access memory (RAM) 105, a database module 107, a keyboard 109 and a display 111.

A text-source data 113 and an ID code 115 are keyed into the microprocessor 103 from the keyboard 109 when user wants to make an inquiry, wherein the text-source data 113 can be words, information related to the words or meanings of the words. Then, the vocabularies that are not under the user's vocabulary knowledge level are displayed on the display 111 by an inquiry procedure performed by the microprocessor 103 according to a bilingual dictionary stored in the database module 107. The ROM 101 is used to store the program of the evaluation system of the present invention, and the RAM 105 is used to save the temporary information of the evaluation system of the present invention. Moreover, a nonvolatile memory, such as flash memory, electric erasable programmable read only memory and etc., can be used as the ROM 101 or for the implement of the database module 107.

In the following description, an English-Chinese bilingual dictionary inquiry system is used as an example to explain the operation of a preferred embodiment of the present invention, and the present invention can be also utilized in other bilingual dictionary inquiry system, such as an English-Chinese/Chinese-English, a Japanese-Chinese/Chinese-Japanese, a Japanese-English/English-Japanese, and an English-Korean/Korean-English bilingual dictionary inquiry system, etc.

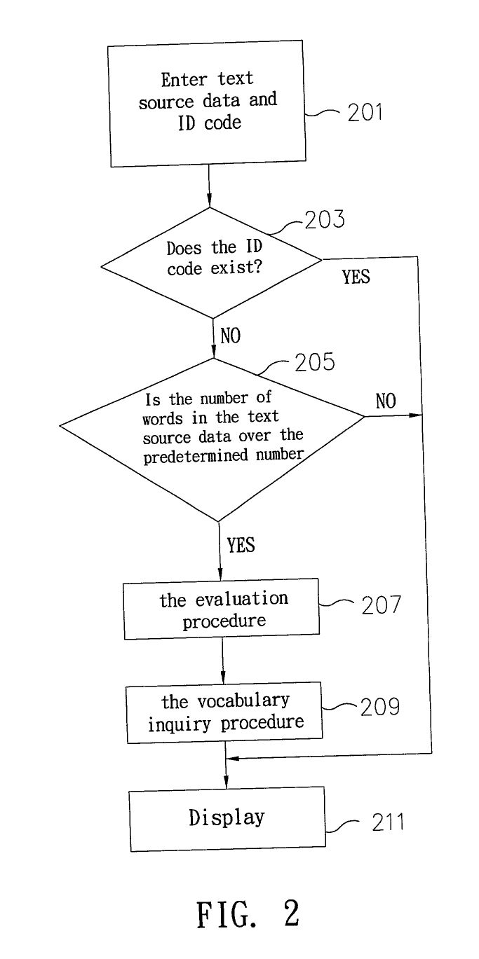

Referring to FIG. 2, FIG. 2 is a flow chart showing the operational procedure of a preferred embodiment of the present invention. First, step 201 is performed for keying the text-source data 113 and the ID code 115 shown in FIG. 1 into the microprocessor 103 by an user from the keyboard 109. Secondly, step 203 is performed for identifying the user in the evaluation system of the present invention. If the ID code 115 has been stored in an user ID database of the database module 107, it means that the evaluation system has ever been accessed by the user, so that a record of the user's vocabulary knowledge level exists in the user ID database. Therefore, according to the user's vocabulary knowledge level previously stored, the vocabulary inquiry procedure step 209 is performed for searching for the text-source data 113, and then step 211 is performed for displaying the words and phrases that are unfamiliar to the user, and the meanings of the text-source data 113.

When the ID code 115 does not exist in the user ID database, step 205 is performed for checking the number of words of the text-source data 113. If the number of words of the text-source data 113 is over a predetermined number, such as 5 or 6 words, then the evaluation procedure step 207 is performed for obtaining the user's vocabulary knowledge level according to the vocabulary level of each word in the text-source data 113. Then, according to the user's vocabulary knowledge level obtained in the evaluation procedure step 207, the vocabulary inquiry procedure step 209 is performed for searching for the text-source data 113, and then step 211 is performed for displaying the words and phrases unfamiliar to the user, and the meaning of the text-source data.

If the number of words of the text-source data 113 is less than a predetermined number, such as 5 or 6 words, the vocabulary inquiry procedure step 209 is performed directly for searching for the text-source data 113, and then step 211 is performed for displaying the meanings of the text-source data 133, since the number of words of the text-source data 133 is not enough for obtaining a proper user's vocabulary knowledge level by the evaluation procedure step 207.

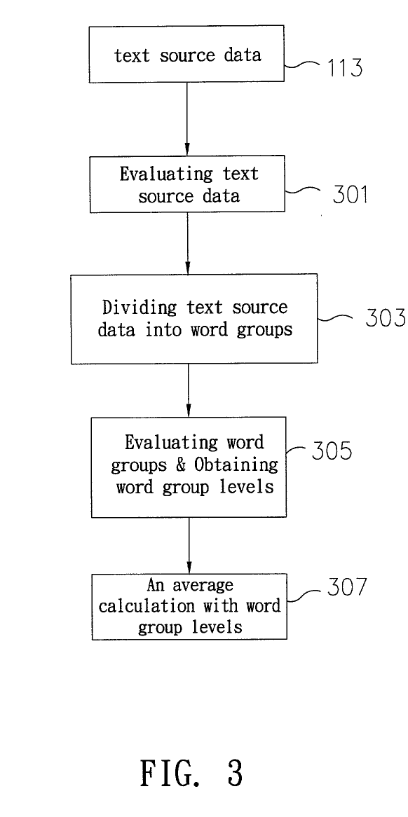

Referring to FIG. 3, FIG. 3 is a flow chart showing the operational procedure of the evaluation procedure step 207 shown in FIG. 2. In the evaluation procedure step 207, step 301 of evaluating the words of the text-source data 113 is first performed for obtaining the vocabulary level of each word in the text-source data 113 according to a classification of vocabulary levels stored in the database module 107 as shown in FIG. 1. Then, step 303 is performed for dividing the text-source data 113 into a plurality of word groups having the same number of words, such as 5 or 6 words. Thereafter, step 305 of evaluating the plurality of word groups is performed for obtaining a plurality of word group levels for the word groups according to the plurality of vocabulary levels of the plurality of words in each word group. Then, the step 307 is performed for obtaining the user's vocabulary knowledge level by calculating the average of the word group levels.

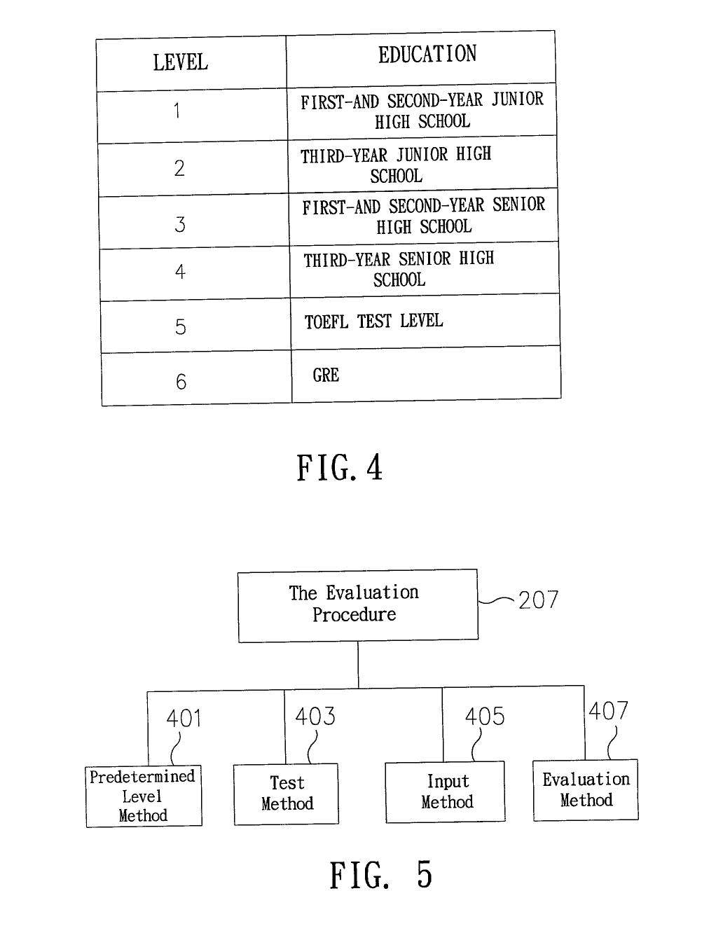

Referring to FIG. 4, FIG. 4 is a table showing the classification of vocabulary level in a preferred embodiment of the present invention. The classification of vocabulary level shown in FIG. 4 is stored in the database module 107, and is based on the vocabularies shown in the textbooks and reference books adopted by Taiwanese high schools, and the questions and review materials for TOEFL and GRE tests. Moreover, the classification of vocabulary levels can be modified when the present invention is utilized in other bilingual dictionary inquiry system.

Referring to FIG. 5, FIG. 5 is a diagram showing several methods for evaluating user's vocabulary knowledge level of a preferred embodiment of the present invention. As shown in FIG. 5, there are several methods for evaluating user's knowledge level. A predetermined level method 401 is to execute the vocabulary inquiry procedure step 209 shown in FIG. 2 for searching for the text-source data 113 according the user's vocabulary knowledge level that has been arranged in the evaluation system. A test method 403 is to execute the vocabulary inquiry procedure step 209 shown in FIG. 2 for searching for the text-source data 113 according the user's vocabulary knowledge level, wherein the user has to take several questions and test for determining his vocabulary knowledge level. An input method 405 is to determine the user's vocabulary knowledge level according to the user's academic degree entered by the user, and an evaluation method 407 is based on the text-source data entered by the user. Therefore, the preferred embodiment of the present invention provides a convenient, easy and diversified evaluation process with several methods available for evaluating and obtaining the user's vocabulary knowledge level.

As shown in FIG. 3, by evaluating a word group, a word group level of the word group can be obtained. In a preferred embodiment of the present invention, Method 1 and Method 2 are used for evaluating the word group. If the word group contains 5 words, the equation of Method 1 becomes

S=[(W₁+W₂+W₃+W₄+W₅)/5] (Method 1)

wherein W₁ is the vocabulary level of the first word of the word group; W₂ is the vocabulary level of the second word of the word group; W₃ is the vocabulary level of the third word of the word group; W₄ is the vocabulary level of the fourth word of the word group; and W₅ is the vocabulary level of the fifth word of the word group, and S is the word group level of the evaluated word group. By utilizing Method 1, the word group level S is the integral part of the average of the vocabulary levels of the words in the evaluated word group, wherein W₁, W₂, W₃, W₄ and W₅ can be obtained from the evaluation based on the classification of vocabulary levels as shown in FIG. 4.

If the word group contains five words, the equation of Method 2 becomes

S=[(((W₁)²+(W₂)²+(W₃)²+(W₄)²+(W₅)²)/5)^{1/2}] (Method 2)

wherein W₁ is the vocabulary level of the first word of the word group; W₂ is the vocabulary level of the second word of the word group; W₃ is the vocabulary level of the third word of the word group; W₄ is the vocabulary level of the fourth word of the word group; and W₅ is the vocabulary level of the fifth word of the word group, and S is the word group level of the evaluated word group.

Method 2 is first to calculate a plurality of square values each of which is the square of the vocabulary level (W₁, W₂, W₃, W₄ or W₅) of each word in the evaluated word group, wherein W₁, W₂, W₃, W₄ and W₅ can be obtained from the evaluation based on the classification of vocabulary levels as shown in FIG. 4, and then to compute an average value of these square values. After a square root value of the average value is calculated, then the word group level S for the evaluated word group can be known by taking the integral part of the square root value.

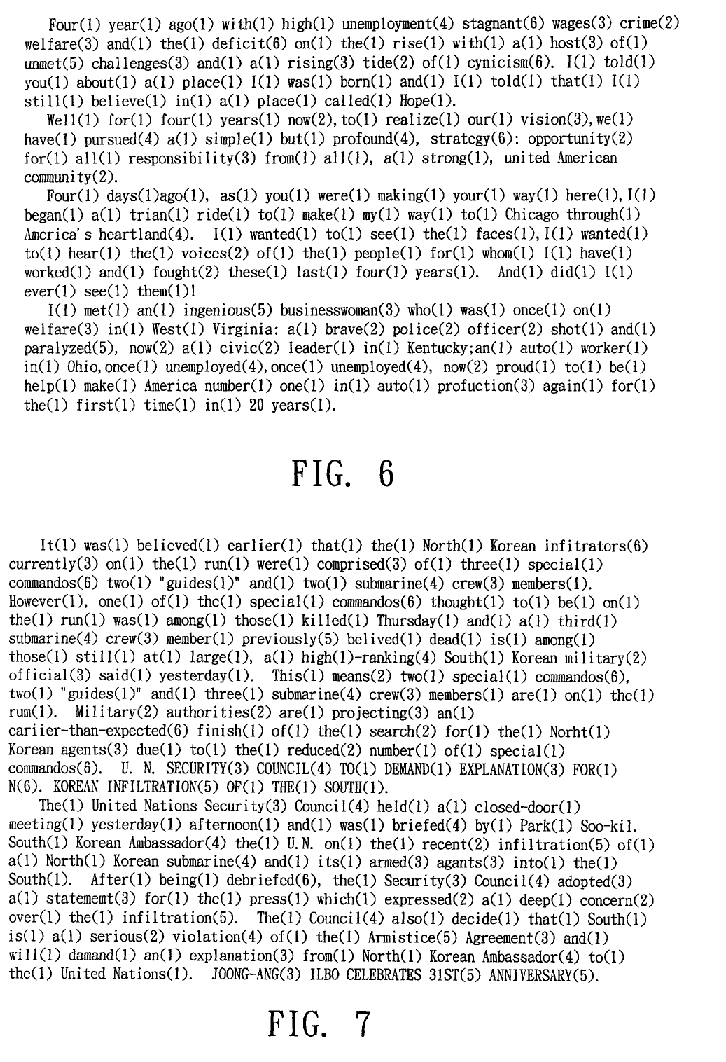

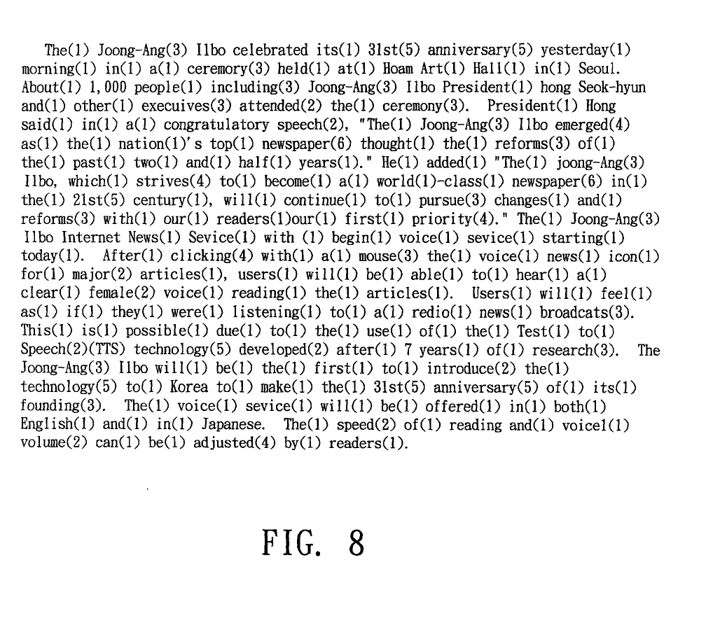

Referring to FIG. 6, FIG. 7 and FIG. 8, FIG. 6, FIG. 7 and FIG. 8 respectively are a first article, a second article and a third article in a preferred embodiment of the present invention, wherein the first article, the second article and the third article are taken from the text-source data 113 shown in FIG. 1. For example, in the article as shown in FIG. 8, the first word group contains the words: “The(1) Joong-Ang(3) Ilbo celebrated its (1) 31st(5) anniversary(5)” wherein the numbers in the parentheses are the vocabulary levels of the words. By Method 1, the word group level is:

[(1+3+1+5+5)/5]=[3.0]=3,

whereas by Method 2, the word group level is:

[((12+32+12+52+52)/5)^{1/2}]=[(61.0/5)^{1/2}]=[3.49]=3

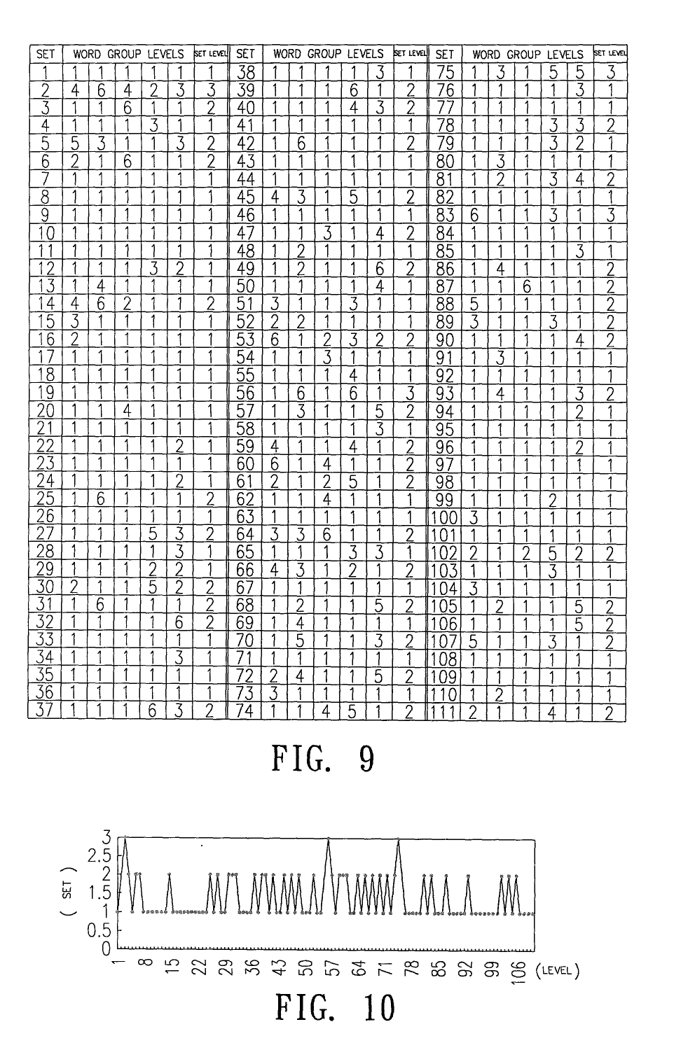

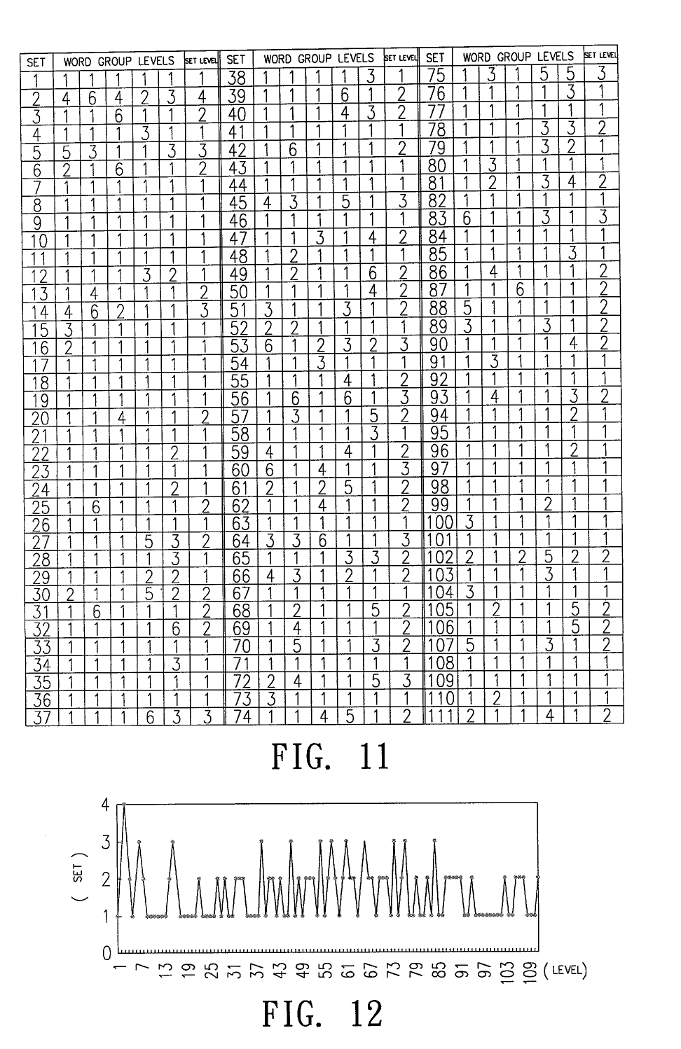

The word group level obtained above is shown in set 75 of the tables shown in FIG. 9 and FIG. 11, wherein FIG. 9 is a table showing the vocabulary levels and the word group levels by applying Method 1 on a combination of the first article, the second article and the third article simultaneously according to a preferred embodiment of the present invention, and FIG. 11 is a table showing the vocabulary levels and the word group levels by applying Method 2 on a combination of the first article, the second article and the third article simultaneously according to a preferred embodiment of the present invention. Moreover, referring to FIG. 10 and FIG. 12, FIG. 10 is a diagram showing the total evaluation result according to FIG. 9, and FIG. 12 is a diagram showing the total evaluation result according to FIG. 11.

By comparing FIG. 10 and FIG. 12, the distribution of word group levels evaluated by Method 1 mainly focuses on level 2, but comparatively, the word group levels evaluated by Method 2 on level 3. Therefore, Method 2 is a better choice method for treating the general articles.

In conclusion, the advantage of the present invention is to provide an evaluation system of vocabulary knowledge level and the method thereof. By utilizing the present invention, an user's vocabulary knowledge level can be obtained automatically without processing any tests in a bilingual vocabulary inquiry system, so that the words and related information that are unfamiliar to the user can be provided directly to the user according to the text-source data entered by the user without demanding the user to go through trivial tests. Therefore, the problem of evaluating the user's vocabulary knowledge level with an inconvenient method in the conventional inquiry system can be resolved.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. An evaluation system of vocabulary knowledge level in a bilingual operating system, comprising:
a first storage module, which is used to store a program of the evaluation system;
a second storage module, which is used to save a temporary information of the evaluation system;
an input interface module, which is used to enter a text-source data and an ID code;
a database module, which is used to store a classification table of vocabulary levels, a bilingual dictionary and an user's ID database;
a microprocessor, which is used to retrieve the temporary information of the evaluation system from the second storage module, the ID code and the text-source data from the input interface module, and to obtain a text information related to the text-source data, an user's vocabulary knowledge level according to the program of the evaluation system stored in the first storage module, the classification table of vocabulary levels, the bilingual dictionary and the user's ID database stored in the database module; and
a display module, which is used to receive and display the text information of the text-source data and the user's vocabulary knowledge level.

2. The evaluation system of vocabulary knowledge level of claim 1, wherein the text-source data is a plurality of articles.

3. The evaluation system of vocabulary knowledge level of claim 1, wherein the first storage module is selected from a group consisting of a read only memory, an electric erasable programmable read only memory and a flash memory.

4. The evaluation system of vocabulary knowledge level of claim 1, wherein the first storage module is a non-volatile memory.

5. The evaluation system of vocabulary knowledge level of claim 1, wherein the database module is a non-volatile memory.

6. The evaluation system of vocabulary knowledge level of claim 1, wherein the database module is selected from a group consisting of a read only memory, an electric erasable programmable read only memory and a flash memory.

7. The evaluation system of vocabulary knowledge level of claim 1, wherein the input interface module is a keyboard.

8. The evaluation system of vocabulary knowledge level of claim 1, wherein the bilingual operating system is selected from a group consisting of an English-Chinese bilingual system, a Chinese-English bilingual system, an English-Japanese bilingual system, a Japanese-English bilingual system, an English-Korean bilingual system, a Korean-English bilingual system, a Japanese-Chinese bilingual system and a Chinese-Japanese bilingual system.

9. The evaluation method of vocabulary knowledge level in a bilingual operating system, comprising:
inputting a text-source data that is consisting of a plurality of words;
inputting an ID code;
performing an ID examination for checking the ID code, wherein an user's vocabulary knowledge level is obtained if the ID code exists in an user's ID database, and a vocabulary inquiry procedure is performed for searching for the text-source data and providing a text information that is related to the text-source data and the grade of the text information that is not under the user's vocabulary knowledge level according to a bilingual dictionary;
performing the ID examination to check the ID code, wherein a calculation step is performed to compute the number of the words of the text-source data if the ID code does not exist in the user's ID database;
performing the vocabulary inquiry procedure for searching for the text-source data and providing the text information that is related to the text-source data according to the bilingual dictionary if the number of words of the text-source data is less than a predetermined number;
performing an evaluation procedure for obtaining the user's vocabulary knowledge level according to a classification table of vocabulary levels if the number of words of the text-source data is more than the predetermined number; and
performing the vocabulary inquiry procedure for searching for the text-source data and obtaining the text information related to the text-source data according to the user's vocabulary knowledge level obtained from the evaluation procedure and the bilingual dictionary; and
displaying the text information.

10. The evaluation method of vocabulary knowledge level of claim 9, wherein the bilingual operating system is selected from a group consisting of an English-Chinese bilingual system, a Chinese-English bilingual system, an English-Japanese bilingual system, a Japanese-English bilingual system, an English-Korean bilingual system, a Korean-English bilingual system, a Japanese-Chinese bilingual system and a Chinese-Japanese bilingual system.

11. The evaluation method of vocabulary knowledge level of claim 9, wherein the evaluation procedure comprises:
dividing the text-source data into a plurality of word groups that have the same number of words;
performing a first word group level evaluation procedure onto the first word group of the plurality of word groups for obtaining a first word group level;
performing a second word group level evaluation procedure to the second word group of the plurality of word groups for obtaining a second word group level;
performing a word group level average calculation to obtain an averaged word group level between the first word group level of the first word group and the second word group level of the second word group; and
obtaining the user's vocabulary knowledge level that is an integral part of the averaged word group level.

12. The evaluation method of vocabulary knowledge level of claim 11, wherein the first word group level evaluation procedure comprises:
evaluating the plurality of words of the first word group to obtain a plurality of vocabulary levels of the first word group according to the classification table of vocabulary levels; and
obtaining the first word group level that is an average of the plurality of vocabulary levels of the first word group.

13. The evaluation method of vocabulary knowledge level of claim 11, wherein the second word group level evaluation procedure comprises:
evaluating the plurality of words of the second word group to obtain a plurality of vocabulary levels of the second word group according to the vocabulary level classification table; and
obtaining the second word group level that is an average of the plurality of vocabulary levels of the second word group.

14. The evaluation method of vocabulary knowledge level of claim 11, wherein the first word group level evaluation procedure comprises:
evaluating the plurality of words of the first word group to obtain a plurality of vocabulary levels of the first word group according to the classification table of vocabulary levels;
obtaining a plurality of square values of the plurality of vocabulary levels of the first word group; and
obtaining the first word group level that is an integral part of a square root of an average of the plurality of square values of the plurality of vocabulary levels.

15. The evaluation method of vocabulary knowledge level of claim 11, wherein the second word group level evaluation procedure comprises:
evaluating the plurality of words of the second word group to obtain a plurality of vocabulary levels of the second word group according to the classification table of vocabulary levels;
obtaining a plurality of square values of the plurality of vocabulary levels of the second word group; and
obtaining the second word group level that is an integral part of a square root of an average of the plurality of square values of the plurality of vocabulary levels.

16. The evaluation method of vocabulary knowledge level of claim 9, wherein the vocabulary level classification table comprising:
level 1, which includes the words that first-year and second-year junior high school students should know;
level 2, which includes the words that third-year junior high school students should know;
level 3, which includes the words that first-year and second-year senior high school students should know;
level 4, which includes the words that third-year senior high school students should know;
level 5, which includes the words that an user who wants to take TOEFL tests should know; and
level 6, which includes the words that an user who wants to take GRE tests should know.

17. The evaluation method of vocabulary knowledge level of claim 9, wherein the predetermined number is 5.

18. The evaluation method of vocabulary knowledge level of claim 9, wherein the evaluation procedure comprises:
inputting an user's academic degree; and
generating the user's vocabulary knowledge level according to the user's academic degree.

19. The evaluation method of vocabulary knowledge level of claim 9, wherein the evaluation procedure comprises a step of generating the user's vocabulary knowledge level that is predetermined.

20. The evaluation method of vocabulary knowledge level of claim 9, wherein the evaluation procedure comprises:
providing a plurality of tests to an user for answering; and
obtaining the user's vocabulary knowledge level according to a plurality of answers of the plurality of tests that are answered by the user.
